(19) United States
(12) Patent Application Publication
(10) Pub. No.: US 2015/0310833 A1
(43) Pub. Date: Oct. 29, 2015

(54) Displaying Hardware Accelerated Video on X Window Systems

(71) Applicants: Juan Zhao, Shanghai (CN); Tomas Frydrych, London (GB); Rui Long, Shanghai (CN); Danming Xie, Shanghai (CN)

(72) Inventors: Juan Zhao, Shanghai (CN); Tomas Frydrych, London (GB); Rui Long, Shanghai (CN); Danming Xie, Shanghai (CN)

(73) Assignee: Intel Corporation, Santa Clara, CA (US)

(21) Appl. No.: 13/995,218

(22) PCT Filed: Sep. 30, 2011
(86) PCT No.: PCT/CN2011/001660

§ 371 Date: Mar. 18, 2015

(51) Int. Cl. G09G 5/14

(52) U.S. Cl. CPC G09G 5/14; G09G 2340/125

(57) ABSTRACT

Multiple planes may be used to enhance the video experience in hardware accelerated video in X window systems. A composite window manager, cursor theme, and more than two ARGB format planes may be used. The window manager handles a transparent area. The area that shows the video is defined as a cutout area. Before the window manager redraws a specific window with the cutout area, the area is set to be transparent or translucent. Then the video can be seen through the cutout with or without overlaid translucent graphics. The cursor theme provides opaque cursors.

### CROSS-REFERENCE TO RELATED APPLICATIONS

This application is a non-provisional application claiming priority to provisional application 61/489,337, filed on May 24, 2011.

### BACKGROUND

This relates generally to video display controllers that control the display of information in computer systems.

In some embedded systems, more than one plane is used to get better performance. Video and window systems run on separate planes. Thus, users need to look through a plane to view the underlying video. For example, for hardware accelerated flash/HTML5 playback, video is rendered on the back plane. Generally, the video needs to be copied to the current plane. But this operation may be expensive for rapidly changing video frames.

### BRIEF DESCRIPTION OF THE DRAWINGS

FIG. 1 is a schematic depiction of one embodiment of the present invention;

FIGS. 2a-2e show the stack up of planes in one embodiment of a multi-plane hardware accelerated video system; and

FIG. 3 is a flow chart for one embodiment of the present invention.

### DETAILED DESCRIPTION

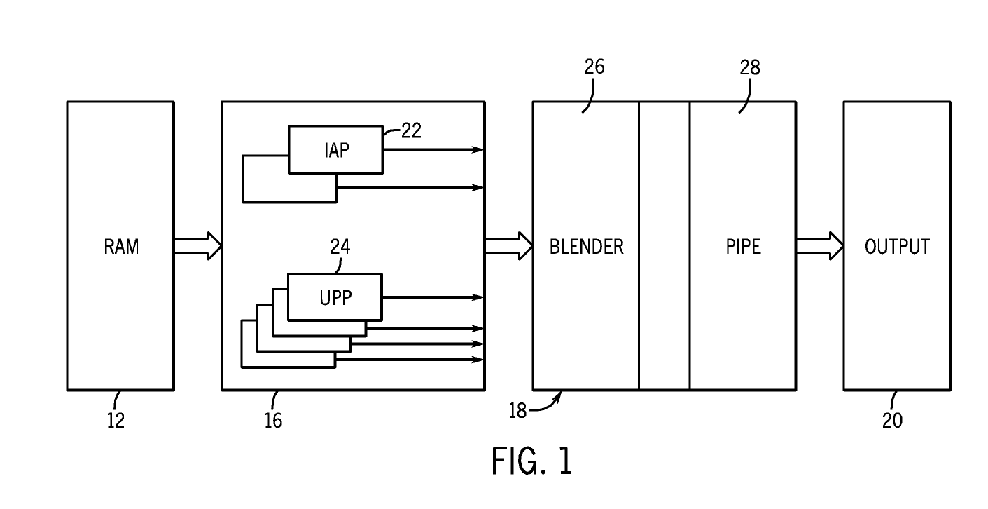

Referring to FIG. 1, a computer system may be an embedded or non-embedded system in one embodiment, such as a set top box, a mobile Internet device, a cellular telephone, a tablet computer, a netbook, a laptop, a personal computer, or a Blu-ray disk player, to mention a few examples.

In some embodiments, an X window system may be utilized. The X window system may provide graphical user interfaces for networked computers. Software may be written using generalized command sets so that programs may be reused on other X window system computers. The X window system follows a modified client-server model wherein the X server communicates with the client level programs. In addition, the X window system provides display and input/output services to applications. A window manager controls the makeup of application windows. X.ORG is one implementation of the X window system. See X11R7.6 (Dec. 20, 2010), available from X.ORG Foundation. Flash and HTML5 video may be supported in a browser, as well as various types of media center client software. However, it would be desirable to display hardware accelerated videos on the X window system.

In accordance with one embodiment, hardware accelerated videos can be displayed on X window systems without copying video from a back plane to the current plane. The video is generally rendered on the lower plane with designated origin and size. On the upper plane, the X desktop and windows are rendered. Specifically, the window for video playback needs to tell the video renderer its origin and size. Thus, it would be desirable to cut a hole on the frame buffer of the window so that the video can be seen.

The X window system does not support multi-plane scenarios. A “plane” is a hardware unit that can read pixel data from a memory buffer and perform transformations on that pixel data. Both graphics and video can be output to planes. A hardware accelerated video processing pipeline can render directly to a plane. Multi-planes are blended in a hardware blender. Different planes may have different capabilities and may support different pixel formats. Generally, plane level transparency would be needed to support hardware accelerated videos in the X window system.

The X server does run on ARGB_{—}32 format plane. ARGB-32 is also known as Red Green Blue Alpha 32 bit that uses the RGB color model. In this format plane, an alpha channel may be used to achieve plane level transparency. However, the X server does not handle the alpha channel by default.

Another problem is that everything on the X window system is transparent to the desktop. Thus, even if you create a 32 bit window, the alpha channel is used for windows compositing, so all of the windows will blend eventually with the desktop. The default behavior of the window manager is to blend all windows with background, no matter whether the window was transparent or not. The background is always opaque, so there is no plane level transparency.

Thus, solutions to these problems can involve the use of ARGB_{—}32 format by defining the alpha blending for all X system elements. Typically, there is no exception for the mouse cursor and the default Xfont cursor does not define an alpha value, leaving the mouse cursor area transparent. This problem may be overcome by replacing the transparent mouse cursor with an opaque cursor theme.

Firstly, a window manager is used to manage the alpha channel. The ARGB_{—}32 plane may be enabled in X.ORG, for example. However, the behavior of translucency depends on whether X applications use 32 bit pixel formats and how the windows are composited by the window manager.

If a compositing window manager is running, the alpha value of the window is recalculated and replaced by the window manager with 1.0, which results in an opaque depiction, regardless of what alpha values the window has. Thus, the window manager treats all 24 bit windows as completely opaque windows, which means their alpha value is 255. For 32 bit windows, some of them need to be blended with the desktop and some need to be blended with lower planes. In the case of a window containing hardware accelerated video, a compositing window manager may reserve the alpha channel of the overlying window to make the plane transparent.

In addition, the compositing window manager may be enhanced to support plane level transparency. One type of plane level transparency is per-pixel transparency, meaning that each pixel can have its own value. Another type of plane level transparency is forced transparency, where each pixel in a rectangle has a zero or transparent alpha value.

For X client applications, the window manager provides hints to communicate with the window manager. The X applications tell the window manager which behavior they expect, per-pixel or forced, and which area of the window is to be transparent, using window manager hints.

Finally, cursor themes are used so that the cursor has a non-zero alpha value so that it will be visible.

With per-pixel transparency, the target area may look translucent to video. The alpha value is variable from zero to 255, depending on the window's alpha values painted into the target area. The contents may be painted in a 32 bit window. The alpha values in the window are used to blend with video. A typical application is that the video player renders some transparent control buttons on the video.

In forced transparency, the target area in the X plane is transparent to the video plane. All contents in the area are ignored and are assigned an alpha value of zero. Thus, it appears that there is a hole in the X plane.

Referring to FIG. 1, a frame buffer 12 may be implemented by random access memory (RAM). It communicates with a system bus 16 which may include multiple planes, including index-alpha planes (IAP) 22 and universal pixel planes (UPP) 24. The system bus may communicate with a video display controller 18 that includes a hardware blender 26 and pipe 28.

In one embodiment, a dedicated media processor implements hardware accelerated video. The display controller provides an output 20 for video display. The video display may be a monitor, a television screen, or a touch screen, to mention a few examples.

The application also tells the window manager where to apply plane level transparency. There are two choices, in one embodiment, either full window or a certain rectangular area of the window, called a cut out area, that are made transparent. In a full window, the entire window is transparent, except for a decoration area. The cut out area may be defined by x and y coordinates with a width, height. The x,y coordinates may be referenced to the top left coordinate relative to the window, in one embodiment.

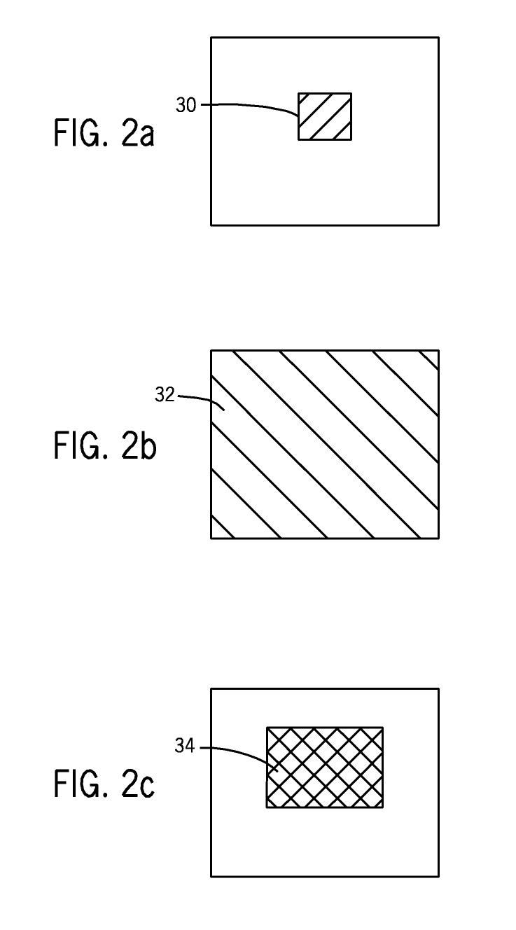

Referring to FIG. 2, the planes of a multi-plane video, in accordance with one embodiment, are illustrated. In FIG. 2a, the plane containing the video 30 is illustrated. Typically, video is on a lower of two planes. A higher plane, shown in FIG. 2b, is used for X application's on-screen 32. Then, in FIG. 2c, a paint window 34 is provided in the higher plane. In FIG. 2d, a cut out area or window 36 is formed in the paint window 34. Finally, the stack up of the cut out area 36, paint window 34, and on-screen 32 is depicted, such that the cut out area 36 allows the underlying video 30 to be viewed, as shown in FIG. 2e.

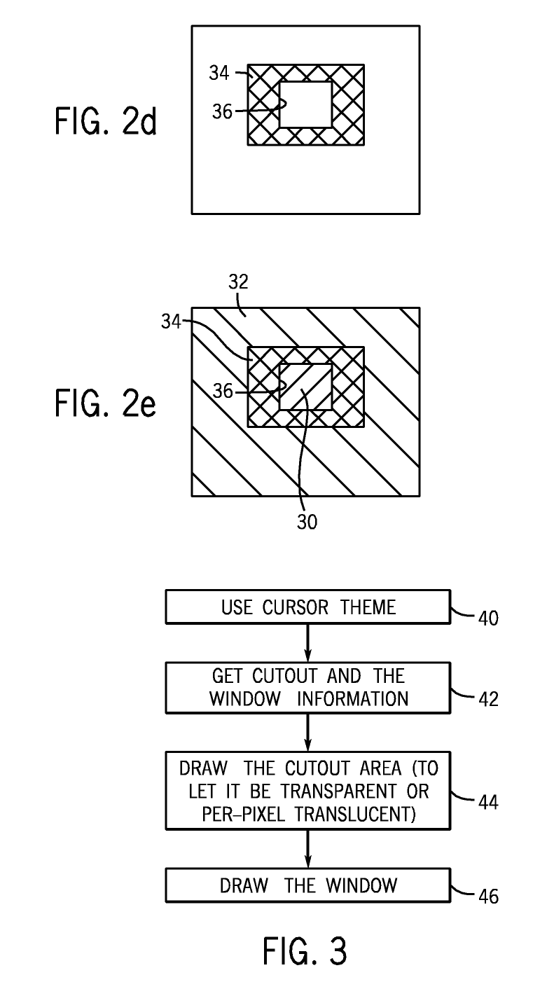

Referring to FIG. 3, a flow chart for one embodiment of a sequence for implementing hardware accelerated video in X window systems may be implemented using hardware, software and/or firmware. In software embodiments, a sequence of instructions may be stored in a non-transitory computer readable medium, such as an optical, magnetic, or semiconductor memory. In one embodiment, the sequence of instructions may be stored within the video display controller 18 of FIG. 1. However, the instructions may also be stored in other places. In some embodiments, the blender 26 is a processor that off loads the blending task from the central processing unit of the system.

The cursor theme sets the cursor to be opaque so that it is visible, as indicated in block 40.

Next, the location and dimensions of the cutout area may be acquired by the window manager, as indicated in block 42. Generally, the X application controls where to apply the plane level transparency and indicates whether full window or cutout is utilized. Then the cutout area is drawn (block 44) so that it may be transparent via forced transparency or using per-pixel translucency. In this case, the window manager supports plane level transparency and implements one of per-pixel translucency or forced transparency. Then, in block 46, the window is actually drawn.

Without limitation, an embodiment using MeeGo television is described. MeeGo is a Linux-based open source mobile operating system. See release 1.1.4/7 Apr. 2011, available at meego.com. The compositing window manager mutter in the MeeGo vertical segment may be enhanced to support multi-plane. Mutter is a short form of the window manager of the Metacity graphics library called Clutter. See GNOME GIT source code repository at git.gnome.org/browse/mutter. It is the default window manager for GNU Network Object Model Environment (GNOME3) graphical user interface that runs on top of an operating system. See GNOME3, available at gnome.org. Mutter is based on the graphics library Clutter and also supports OpenGL by Clutter. Mutter is extensible with plug-ins.

When the plug-in mutter MeeGo television receives the paint signal, it cuts out the video area in X.ORG's plane. The transparency behavior results from a cleanup operation before or after drawing the target window. “Cleanup” means to paint zero as the alpha value to the target area that will blend with lower planes. Cleanup before and cleanup after result in different transparency effects.

Mutter tells the applications to redirect windows to pixel maps and uses a texture from the pixel map technology to translate them to textures. With the hints it receives, the mutter plug-in blends the cutout area with textures.

In the lower plane, the video frame is painted in the right place for hardware blending. In the upper plane, the desktop and some other windows may have already been painted. Then the window is drawn that contains the video player.

Cleanup before drawing works to achieve per-pixel translucency. In cleanup before, a desktop background and some windows have already been drawn. The target area is cleared with zero alpha values and then the window is drawn. The current window's value is completely reserved. If it has translucent alpha values, they have also been reserved.

If the cleanup occurs after drawing, the desktop background and some windows have already been drawn. This time, the window is drawn first. Then it blends with the other windows in the desktop. After that, certain areas of the target are cleaned up with alpha value zero, so those areas will be transparent.

Multi-plane applications may be written using legacy applications. If they do not set hints, the window manager takes the default behavior. The 24 bit windows are opaque and 32 bit windows are composited with X elements, but not the lower planes. For multi-plane applications, either a cutout area may be specified or the full screen may be transparent. Also, the applications tell the window manager whether per-pixel translucency or forced transparency is being used. Finally, the cursor theme should be supplied to support opaque cursors. So an example of a hint is provided below.

| meego-tv-cutout-x | | | | |
|---|---|---|---|---|
| meego-tv-cutout-y | | | | |
| meego-tv-cutout-width | meego-tv- | meego-tv- | Result | |
| meego-tv-cutout height | half-trans | full-window | area | feature |
| X, y, width, height | 0 | 0 | Defined Cutout area | Forced Transparency |
| X, y, width, height | 0 | 1 | Full window | Forced Transparency |
| X, y, width, height | 1 | 0 | Defined cutout area | Per-Pixel Translucency |
| X, y, width, height | 1 | 1 | Full window | Per-Pixel Translucency |

The chart shows a combination of four hints. The first column specifies a cutout area. The cutout areas in the second and fourth rows of the chart are ignored since full screen is defined. The second column specifies whether the cutout area is per-pixel translucent, and the third column specifies whether the plane level of transparency will apply the full screen. The following code may be used for Xlib applications to set the hints.

property = XinternAtom (dpy “_MUTTER_HINTS”,0),
data = “meego-tv-cutout-x=140:meego-tv-cutout-y=40:meego-tv-cutout=width=100:meego-tv-cutout-
height=100:meego-tv-half-trans-0:meego-tv-full-window=0”;
XChangeProperty(dpy,win,property,XA_STRING,8,PropMadeReplace,(unsigned char
*)data,strlen(data));

The key point is to define target areas for forced transparency and per-pixel translucency and to paint the alpha values when using per-pixel translucency. Thus, the alpha value is redrawn directly. As examples, the redraw operation can be handled by OpenGL (see OpenGL 4.1, available from OpenGL.org) or the X render extension of X.ORG.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
implementing multiple planes to enable hardware accelerated video on X window systems.

2. The method of claim 1 including designating a region to apply plane level transparency.

3. The method of claim 2 including applying plane level transparency to a cutout area.

4. The method of claim 3 including playing a video in a lower plane, said video being visible through said cutout area.

5. The method of claim 4 including using a second plane over said lower plane for an X application's on-screen.

6. The method of claim 5 including providing a paint window over said second plane.

7. The method of claim 6 including providing a cutout area over the paint window.

8. The method of claim 1 including setting a cursor to be opaque.

9. The method of claim 1 including making video visible through a transparent region of a plane.

10. A non-transitory computer readable medium storing instructions executed by a computer to perform a sequence comprising:
implementing multiple planes to enable hardware accelerated video on an X window system.

11. The medium of claim 10 storing instructions to perform a sequence including designating a region to apply plane level transparency.

12. The medium of claim 11 storing instructions to perform a sequence including applying plane level transparency to a cutout area.

13. The medium of claim 12 storing instructions to perform a sequence including playing a video in a lower plane, said video being visible through said cutout area.

14. The medium of claim 13 storing instructions to perform a sequence including using a second plane over said lower plane for an X application's on-screen.

15. The medium of claim 14 storing instructions to perform a sequence including providing a paint window over said second plane.

16. An X window system comprising;
multiple planes to accelerate video on said system; and
a memory buffer coupled to said planes.

17. The system of claim 16 including a processor to designate a region to apply plane level transparency.

18. The system of claim 17 to play a video in one plane visible through a transparent region in another plane.

19. The system of claim 17, said processor to set a cursor to opaque.

20. The system of claim 17, said processor to form the transparent region using forced transparency or per pixel transparency.
